(19) United States
(12) Patent Application Publication
(10) Pub. No.: US 2022/0126469 A1
(43) Pub. Date: Apr. 28, 2022

(54) PACKAGING BOX FOR RECEIVING BLADE OF MANUAL RAZOR

(71) Applicant: Xiaojie Huang, Shenzhen (CN)

(72) Inventor: Xiaojie Huang, Shenzhen (CN)

(21) Appl. No.: 17/135,976

(22) Filed: Dec. 28, 2020

(30) Foreign Application Priority Data
Oct. 27, 2020 (CN) 202022423614. 4

(51) Int. Cl. B26B 21/40; A45D 27/22

(52) U.S. Cl. CPC B26B 21/4037; A45D 27/225; B26B 21/4025

(57) ABSTRACT

A packaging box for receiving blades of a manual razor according to the present disclosure includes a base and a shielding detachably covered on the base. The base includes a bottom plate and a projecting platform extending upwardly from an upper surface of the bottom plate and embedded in the shielding, at least one receiving groove formed on the projecting platform for receiving the blades therein; a first metal block arranged on the base for adsorbing the shielding and a pair of projecting portions respectively arranged on both sides of the projecting platform for handholding; a second metal block corresponding to the first metal block arranged on the shielding. One of the first and second metal blocks is a magnet, and the other is a metal or a magnet configured to adsorb with the magnet; a pair of notches arranged on the shielding for engaging with corresponding projecting portions.

### TECHNICAL FIELD

The present disclosure generally relates to daily nursing products field, and especially relates to a packaging box for receiving blades of a manual razor.

### DESCRIPTION OF RELATED ART

With continuous development of economy and continuous prowess of society, material consumer goods have become more and more abundant for creating good conditions in order to improve people's living standard and pursue personalized life, which also speed up demands for the consumer goods, for example, a razor is one of the consumer goods.

It is well known that conventional razors are divided into two types of a manual razor and an electric shaver. For the manual razor, because it has advantages of more thorough shaving without a power supply, it occupies a considerable share in the market. However, the conventional manual razor usually lacks a storage device to receive blades of the razor therein, which leads to troubles of taking, putting and replacing the blades, and brings inconvenience to consumers. Therefore, it is necessary to design the storage device for the conventional manual razor to receive the blades, so as to conveniently take or put the blades, to improve better product experience of consumers, and make life more orderly.

### SUMMARY

The technical problems to be solved: in view of the shortcomings of the related art, the present disclosure relates to a packaging box for receiving blades of a manual razor which can connect the base with the shielding to form the packaging box for receiving the blades in an orderly way, which is more convenient to take and change the blades so as to avoid the loss of the blades.

The technical solution adopted for solving technical problems of the present disclosure is:

a packaging box for receiving blades of a manual razor according to an embodiment of the present disclosure includes a base and a shielding detachably covered on the base. The base includes a bottom plate and a projecting platform extending upwardly from an upper surface of the bottom plate and embedded in the shielding, at least one receiving groove formed on the projecting platform for receiving the blades therein; at least one first metal block arranged on the base for adsorbing the shielding and a pair of projecting portions respectively arranged on both sides of the projecting platform for handholding; at least one second metal block corresponding to the at least one first metal block arranged, on the shielding. One of the at least one first metal block and the at least one second metal block is a magnet, and the other is a metal or a magnet configured to adsorb with the magnet; a pair of notches arranged on the shielding for engaging with corresponding projecting portions, with both sides of the projecting portion being located outside the notch.

As a preferred embodiment, wherein a locating groove is downwardly-concave arranged on an upper portion of the shielding for receiving a handle of the razor therein.

As a preferred embodiment, wherein a mirror is arranged on an inner bottom portion of the shielding.

As a preferred embodiment, wherein at least one concave recess is arranged on the inner bottom portion of the shielding, a magnet is arranged in the concave recess so that the shielding can be adsorbed with a metal component by the magnet, a cover plate arranged on the inner bottom portion of the shielding to cover on the magnet, the mirror arranged on a top surface of the cover plate.

As a preferred embodiment, wherein the cover plate includes an embedding slot formed on the top surface thereof for receiving the mirror therein.

As a preferred embodiment, wherein the at least one first metal block is embedded in a corresponding projecting portion, a pair of concave portions respectively arranged on two ends of the pair of notches, the at least one second metal block arranged on a corresponding concave portion.

As a preferred embodiment, wherein both the at least one first metal block and the at least one second metal block are magnets and can be adsorbed with each other.

As a preferred embodiment, wherein a silicone pad is arranged on a lower surface of the bottom plate.

As a preferred embodiment, wherein the at least one receiving groove includes a plurality of receiving grooves arranged side by side on the projecting platform of the base.

As a preferred embodiment, wherein a pair of concave parts respectively arranged on an outer sidewall of the pair of projecting portions for handholding.

The present disclosure provides the advantages as below. Specifically, it can be known from the above technical scheme, the packaging box is provided that the base is connected with the shielding to form the packaging box for receiving the blades in an orderly way. When the razor is used by a user, the blades can be found at a first time, which is more convenient to take and change the blades so as to avoid the loss of the blades. At the same time, the packaging box is adopted to a magnetic suction type combination, with tight coordination, so that the packaging box can be quickly and easily opened and closed; furthermore, the packaging box has a certain waterproof function, so as to be played as a role of protecting the blades; in addition, the packaging box is compact and light in volume to be convenient for being travelled.

### BRIEF DESCRIPTION OF THE DRAWINGS

In order to more clearly understand the technical solution hereinafter in embodiments of the present disclosure, a brief description to the drawings used in detailed description of embodiments hereinafter is provided thereof.

FIG. 1 is a schematic view of a packaging box for receiving blades of a manual razor in accordance with an embodiment of the present disclosure.

FIG. 2 is similar to FIG. 1, but shown from another view.

FIG. 3 is a schematic, exploded view of the packaging box of FIG. 1.

FIG. 4 is similar to FIG. 3, but shown from another view.

FIG. 5 is a schematic, exploded view of a shielding of the packaging box of FIG. 1.

FIG. 6 is an inner schematic view of the shielding of the packaging box of FIG. 1.

FIG. 7 is a bottom schematic view of a base of the packaging box of FIG. 1.

FIG. 8 is a schematic view of a distribution structure of receiving grooves of the packaging box of FIG. 1.

The element, labels according to the embodiment of the present disclosure shown as below:
base 10, bottom plate 11, upper surface 11a, lower surface 11b, receiving room 111, silicone pad 112, projecting platform 12, receiving groove 13, projecting portion 14, top end 14a, outer sidewall 14b, first metal block 15, concave part 16, shielding 20, upper portion 20a, bottom portion 20b, notch 21, concave portion 22, second metal block 23, locating groove 24, mirror 25, concave recess 26, magnet 27, cover plate 28, top surface 28a, embedding slot 281.

### DETAILED DESCRIPTION

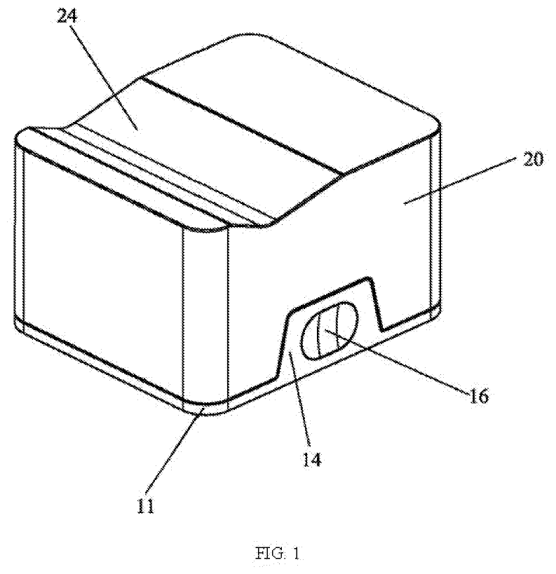

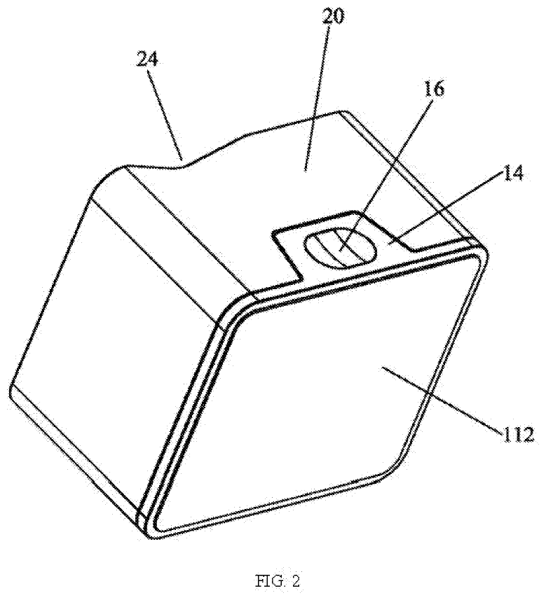

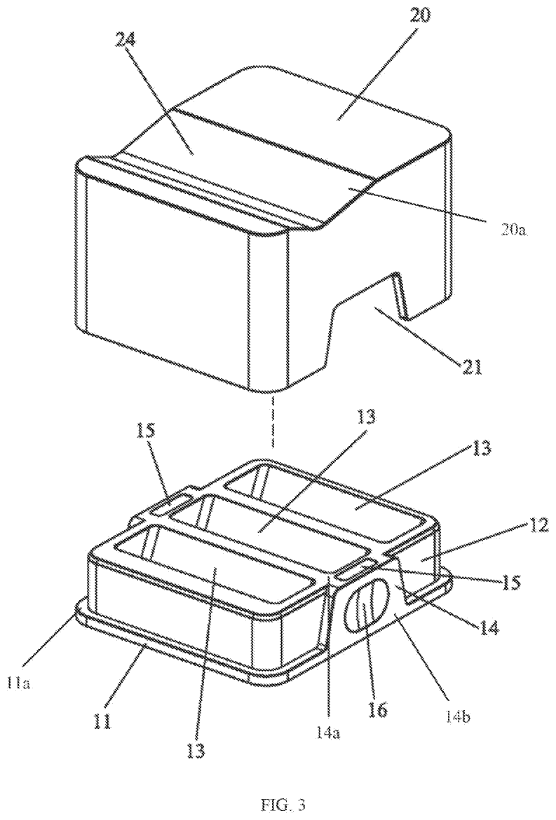

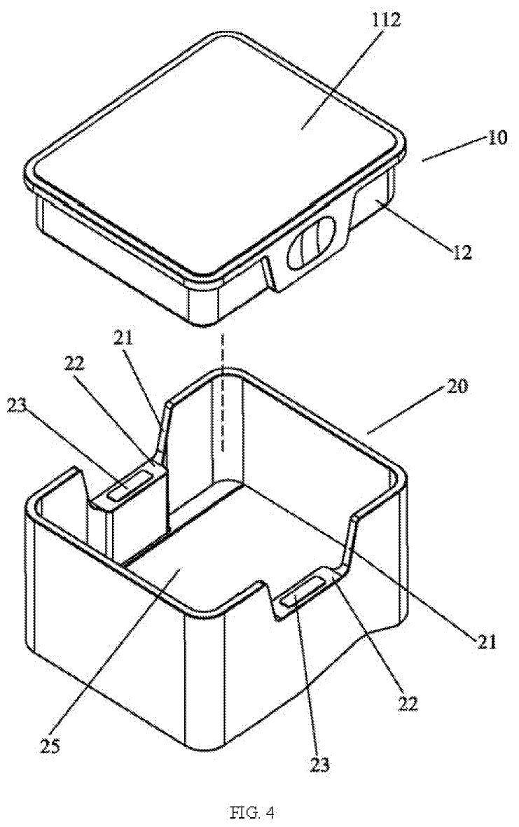

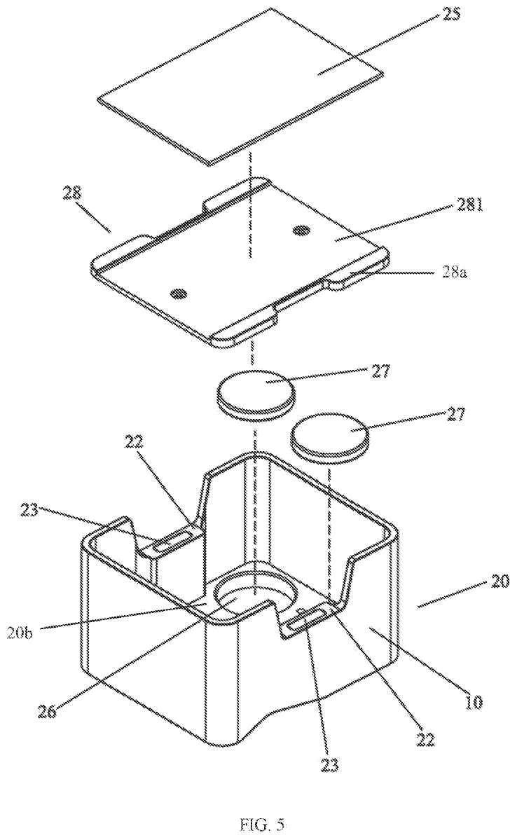

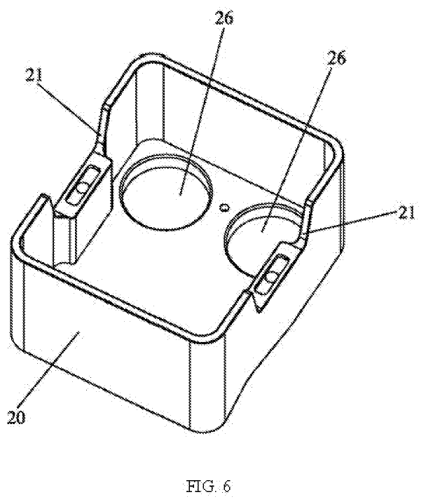

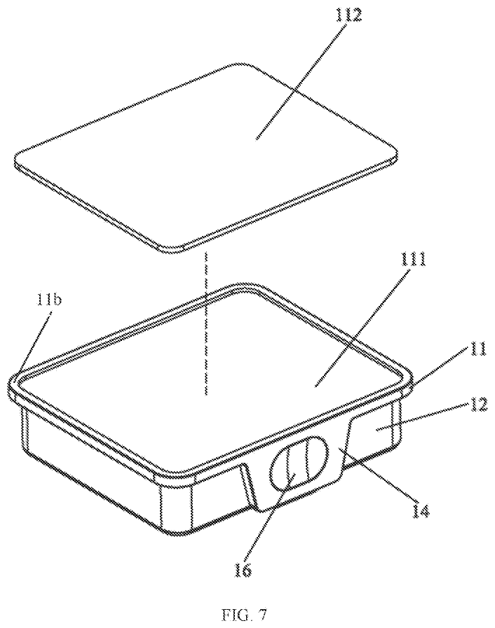

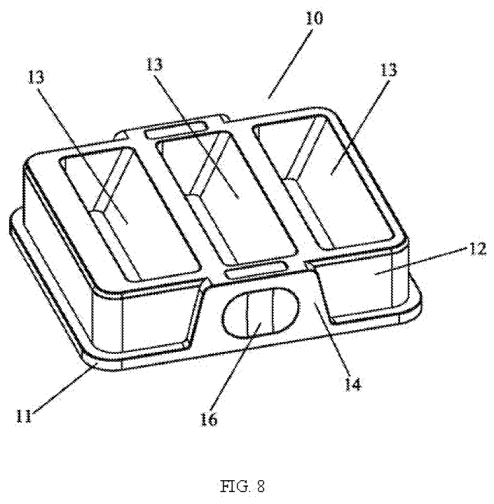

Referring to FIGS. 1-8, a packaging box for receiving blades of a manual razor according to an embodiment of the present disclosure includes a base 10 and a shielding 20, wherein:

the base 10 includes a bottom plate 11 and a projecting platform 12 extending upwardly from an upper surface 11a of the bottom plate 12, and a receiving room 111 arranged on a lower surface 11b of the bottom plate 11. A silicone pad 112 is arranged on the receiving room 111 to prevent the packaging box from being slipped when the packaging box is placed on a table or other objects. At least one receiving groove 13 is formed on the projecting platform 12 for receiving the blades therein, in an embodiment of the present disclosure, there are three receiving grooves 13 arranged side by side on the projecting platform 12, and the three receiving grooves 13 all are inclined towards a same direction, so that the blades received in each of the three receiving grooves 13 are towards the same direction, so as to place the blades more orderly. A pair of projecting portions 14 is respectively arranged on both sides of the projecting platform 12, a pair of first metal blocks 15 is embedded into a top end 14a of the projecting portion 14 respectively for adsorbing the shielding 20.

The shielding 20 is detachably covered on the base 10, and the projecting platform 12 is embedded in the shielding 20. A pair of notches 21 is arranged on both sides of the shielding 20 and corresponding to the pair of projecting portions 14 of the base 10, respectively, and a pair of concave portions 22 is respectively arranged on two ends of the pair of notches 21 (the concave portion 22 is protruded inside of the shielding 20 so as to reduce a volume of the shielding 20 and obtain a more neat and compact overall structure). A pair of second metal blocks 23 is respectively arranged on the top of the concave portion 22 on both sides thereof, one of the first metal block 15 and the second metal block 23 is a magnet, and the other is a metal or a magnet configured to adsorb with the magnet. In an embodiment of the present disclosure, both the first metal block 15 and the second metal block 23 are magnets and can be adsorbed with each other. After the shielding 20 is covered on the base 10, the first metal block 15 is adsorbed with the second metal block 23, the projecting platform 12 of the base 10 is fully received in the shielding 20, the projecting portion 14 is extended outwardly form the notch 21 of the shielding 20. A pair of concave parts 16 is respectively arranged on an outer sidewall 14b of the pair of projecting portions 14 for conveniently handholding, so that the base 10 and the shielding 20 can be manually separated.

In addition, a locating groove 24 is downwardly-concave arranged on an upper portion 20a of the shielding 20 for receiving a handle of the razor therein. And then, in order to further improve a user's convenience, a mirror 25 is arranged in an inner bottom portion 20b of the shielding 20 for looking at the mirror 25, which is mainly provided the user with a condition that can look from the mirror in the absence of other mirrors. In order that the shielding 20 can be fixed vertically on a wall or an object surface, at least one concave recess 26 is arranged on the inner bottom portion 20b of the shielding 20 (in an embodiment of the present disclosure, there are a pair of concave recesses 26). A magnet 27 is arranged in the concave recess 26 so that the shielding 20 can be adsorbed with a metal component by the magnet 27, thereby the user is allowed to look from the mirror during shaving. A cover plate 28 is arranged on the inner bottom portion 20b of the shielding 20 and covered on the magnet 27 to fix the magnet 27 in the shielding 20 (the cover plate 28 is made of metal, and fixed to the inner bottom portion 20b of the shielding 20 by screws, and the cover plate 28 and the inner bottom portion 20b of the shielding 20 are provided with holes, respectively). The cover plate 28 includes an embedding slot 281 formed on a top surface 28a thereof for receiving the mirror 25 therein.

The usage of the packaging box is as follows: when the packaging box is used, the shielding 20 can be separated from the base 10 by holding the concave part 16, and then the blade is taken out from the receiving groove 13 of the base 10 and then installed on the razor (or replaced the original blade on the razor). In the absence of a mirror, the mirror 25 received in the shielding 20 can meet the needs of being looked therefrom. In particular, the shielding 20 can be adsorbed and fixed on metal objects through the magnet 27 in the shielding 20 for realizing to shave based on the mirror 25. At the same time, when using the packaging box, the locating groove 24 of the shielding 20 can be used to place the razor in the same position for each usage, so as to avoid inconvenience of finding the razor in a next use due to the placement of the razor in other positions. In addition, the locating groove 24 can make the razor be placed in the air to avoid from being dusted. Extra blades are received in the locating groove 24 and then the base 10 and the shielding 20 are closed together, so that the base 10 and the shielding 20 are absorbed with each other by the magnets to be closely matched, so as to obtain a certain waterproof effect.

The design emphasis of the present disclosure is as follows: the packaging box is provided that the base is connected with the shielding to form the packaging box for receiving the blades in an orderly way. When the razor is used by a user, the blades can be found at a first time, which is more convenient to take and change the blades so as to avoid the loss of the blades. At the same time, the packaging box is adopted to a magnetic suction type combination, with tight coordination, so that the packaging box can be quickly and easily opened and closed; furthermore, the packaging box has a certain waterproof function, so as to be played as a role of protecting the blades; in addition, the packaging box is compact and light in volume to be convenient for being travelled.

Although the features and elements of the present disclosure are described as embodiments in particular combinations, each feature or element can be used alone or in other various combinations within the principles of the present disclosure to the full extent indicated by the broad general meaning of the terms in which the appended claims are expressed. Any variation or replacement made by one of ordinary skill in the related art without departing from the spirit of the present disclosure shall fall within the protection scope of the present disclosure.

What is claimed is:

1. A packaging box for receiving blades of a manual razor comprising:
a base and a shielding detachably covered on the base, a bottom plate, and a projecting platform extending upwardly from an upper surface of the bottom plate and embedded in the shielding, at least one receiving groove formed on the projecting platform for receiving the blades therein; at least one first metal block arranged on the base for adsorbing the shielding, and a pair of projecting portions respectively arranged on both sides of the projecting platform for handholding; at least one second metal block corresponding to the at least one first metal block arranged on the shielding; and wherein
one of the at least one first metal block and the at least one second metal block is a magnet, and the other is a metal or a magnet configured to adsorb with the magnet; a pair of notches is arranged on two opposite sides of the shielding for engaging with corresponding projecting portions, with both sides of the projecting portion being located outside the notch.

2. The packaging box as claimed in claim 1, wherein a locating groove is downwardly-concave arranged on an upper portion of the shielding for receiving a handle of the razor therein.

3. The packaging box as claimed in claim 1, wherein a mirror is arranged on an inner bottom portion of the shielding.

4. The packaging box as claimed in claim 3, wherein at least one concave recess is arranged on the inner bottom portion of the shielding, a magnet is arranged in the concave recess so that the shielding can be adsorbed with a metal component by the magnet, a cover plate arranged on the inner bottom portion of the shielding to cover on the magnet, the mirror arranged on a top surface of the cover plate.

5. The packaging box as claimed in claim 4, wherein the cover plate comprises an embedding slot formed on the top surface thereof for receiving the mirror therein.

6. The packaging box as claimed in claim 1, wherein the at least one first metal block is embedded in a corresponding projecting portion, a pair of concave portions respectively arranged on two ends of the pair of notches, the at least one second metal block arranged on a corresponding concave portion.

7. The packaging box as claimed in claim 1, wherein both the at least one first metal block and the at least one second metal block are magnets and can be adsorbed with each other.

8. The packaging box as claimed in claim 1, wherein a silicone pad is arranged on a lower surface of the bottom plate.

9. The packaging box as claimed in claim 1, wherein the at least one receiving groove comprises a plurality of receiving grooves arranged side by side on the projecting platform of the base.

10. The packaging box as claimed in claim 1, wherein a pair of concave parts respectively arranged on an outer sidewall of the pair of projecting portions for handholding.
